(19) United States
(12) Patent Application Publication
(10) Pub. No.: US 2014/0251211 A1
(43) Pub. Date: Sep. 11, 2014

(54) Paintover Tape Patterns and Shapes

(71) Applicant: Miriam Faraci, Chicago, IL (US)

(72) Inventor: Miriam Faraci, Chicago, IL (US)

(21) Appl. No.: 13/792,536

(22) Filed: Mar. 11, 2013

(51) Int. Cl. B05B 15/04

(52) U.S. Cl. CPC B05B 15/0456
USPC 118/505

(57) ABSTRACT

The present invention is a system for applying continual curvilinear, circular, or geometric painted patterns to a wall or target surface with a correctly aligned number of adjacent adhesive sheets or tiles of contact paper to create an uninterrupted pattern. If these individual adhesive sheets are placed in a row or column, similar to ceramic tiles application, the final reveal is a continual pattern or design. The adhesive sheets or tiles are terms meant to encompass individual larger sheets of adhesive contact paper. These serve as masking tape cut in a shape or pattern and applied to transfer paper with guidelines to create proper alignment. The cut out sheets of contact paper are decorative in nature and are configured to prevent the passage of paint through the body to a target surface or wall. The patterns could take the form of any shape that could be successfully excised from the body of the adhesive sheet of contact paper, specifically to help with curvilinear and circular patterns which are not possible to achieve with just linear painters' tape or masking tape. The adhesive sheets or tiles also include a cleanly-releasable adhesive compound on a ventral surface of the adhesive sheet. The adhesive compound is a substance capable of bonding to a surface for a limited period of time without leaving a substantial amount of residue.

### FIELD OF THE INVENTION

The present invention relates to the field of decorative painting and more specifically to the field of applying a curvilinear, circular or geometric patterns to the targeted surface using clean-releasing decorative sheets of compound paper cut into pattern forms (similar to so-called painters' tape) for decorating a surface, revealing a pattern.

### BACKGROUND

Applying a curvilinear or circular painted pattern on a wall or other target surface is a skill that few people possess and can execute with precision. The actual painting process is very complicated and extremely time-consuming. To ensure that the pattern is transferred onto the surface correctly, the painter must first transfer the image of the pattern onto the wall or surface using transfer paper or draw the pattern by hand. Then, using a small brush to fill in the pattern by hand, making sure not to accidentally paint beyond the boundary to maintain a sharp edge to the pattern.

Another option is to use a stencil, which is a sheet of plastic with a pattern reveal. This sheet is attached to the wall with strips of tape and paint is applied over the stencil with a roller or stencil brush. The stencil is lifted while the paint is still wet and aligned next to the painted pattern for continuation of the pattern. The stencil is placed very carefully so as not to transfer the still-wet paint, re-attached with tape, and paint is once again applied over the stencil. This process in repeated until the entire surface is covered with the desired pattern. This particular application is very messy as it requires working with wet paint. It is difficult to apply, does not provide a sharp edge (as paint tends to bleed behind the stencil), and the painter cannot successfully apply the two coats of paint that are often required for proper coverage.

If the intended pattern contains straight edges or geometric shapes with straight-edged segments, the painter can use painters' tape to completely shield the pattern before painting the entire surface. The painter can then peel off the tape to reveal the pattern. It is however not possible to produce curvilinear or circular patterns in this way due to the linear nature of straight-edged tape.

Masking tape has a strong adhesive that may pull paint and finish off of the masked area upon removal. Among masking tapes, there is a specialized type of tape known as painters' tape, which can be found at any major home maintenance store. Painters' tape differs from conventional or masking tape in that it uses an adhesive with unique bonding qualities. Painters' tape can adhere to a surface and then, after a reasonable period of time, is removed without adhesive transfer or surface damage.

Painters' tape contains a milder adhesive than masking tape. Many adhesive compounds, and variations thereof, can be used with painters' tape; and the choice of adhesive typically depends upon three primary factors: the surface targeted for painting, the expected length of time that the tape will remain on the surface, and the environmental conditions in which the tape will find itself. Low adhesion painters' tape is ideal for smooth, freshly painted surfaces, faux painting, wood floors and glass; medium adhesion painters' tape is ideal for painted walls and trim, woodwork, glass and metal. Painters' tape is further rated by the length of time it can remain adhered to a location prior to transferring a substantial amount of adhesive to surface upon which it is affixed. Painters' tape can be purchased with a rating of 7 to 14 days or more.

The unique qualities of painters' tape could be utilized to cleanly create designs on surfaces, mask the areas and shield them from cop coat paint color, revealing pattern once removed, but as mentioned in point 04 above, it can only create straight edge geometric designs. Previous attempts to create curvilinear and circular designs on surfaces, or shield surfaces from paint to create pattern, with adherent articles have yet to produce a satisfactory process or method permitting curvilinear or circular design creation with an adherent article. Information relevant to attempts to address these problems can be found in U.S. Pat. Nos. U.S. 2008/0020181; 4,082,875; 4,420,520; 4,430,137; 5,786,028; 7,022,188; D490, 855; and D491, 229. However, each one of these references suffers from one or more of the following disadvantages: lack of satisfactorily clean adhesion that prevents surface damage while simultaneously preventing unwanted paint transfer, inability to create curvilinear or circular design with sharp edges, the inability to allow a user to define the required dimensions, and structure requiring a user to undertake additional work to prepare a pattern.

Therefore, there is a need for a simple method permitting curvilinear or circular pattern design of painted surfaces, creating sharp edges not requiring freehand drawing or stenciling, a method that includes an adhesive compound that cleanly releases from a great range of target surfaces.

### SUMMARY

The present invention is a system for applying continual curvilinear, circular or geometric painted patterns to a wall or target surface with a correctly aligned number of adjacent adhesive sheets or tiles of contact paper pattern forms. If these individual adhesive patterns are placed in a row or column, similar to ceramic tiles application, the final reveal is a continual pattern. The adhesive sheet pattern, a term meant to encompass individual larger sheets of adhesive contact paper forms serving as masking tape cut in a shape of pattern applied on transfer paper with lead lines to guide aligning. The body of the pattern could include inner recesses, i.e. recesses substantially enclosed within the continuous body; outer recesses, i.e. recesses affecting the dimensions of the outer edge of the sheet; or a combination of outer recesses and inner recesses.

The body of cut-out patterns from the sheets of contact paper are decorative in nature and are configured to prevent the passage of paint through the body to a target surface or wall. The patterns could take the form of any shape that could be successfully excised from the body of the adhesive sheet of contact paper. For example, the designs and recesses could comprise of circles, curvilinear forms, geometric shapes, scenic designs, repeated patterns, etc.

The adhesive sheets further include a cleanly-releasable adhesive compound on a ventral surface of the adhesive sheet. The adhesive compound is a substance capable of bonding to a surface for a limited period of time without leaving a substantial amount of residue. The ideal adhesive compounds for the present invention include those found, or capable of use, in painters' tape. Painters' tape adhesives are made for use in projects where the tape will adhere to a surface for less than a specified period of time, and if released prior to that specified period of time, will leave substantially no residue on the target surface. Examples of common target surfaces include painted walls and trim, woodwork, cabinetry, glass, faux painting, and wood floors.

Therefore, it is an aspect of the present invention to produce a simple system capable of applying larger or smaller curvilinear, circular and geometric decorative patterns to a target surface that cleanly releases from a great range of target surfaces.

Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a wall elevation view, an adhesive pattern applied on the wall

FIG. 2 is a single sheet or tile, plan view of adhesive pattern example.

FIG. 3 is a ½ of sheet or tile, plan view of adhesive pattern example.

FIG. 4 is a stipe of joined tiles or sheets, plan view of adhesive pattern strip.

FIG. 5 is a single sheet or tile, plan view of adhesive paper pattern example with transfer paper and backing paper.

FIG. 6 is an elevation view of the strip of adhesive paper pattern of the present invention.

FIG. 7 is an elevation view of the strip of adhesive paper pattern of the present invention with paint being applied.

FIG. 8 is an elevation view of the strip of adhesive paper pattern of the present invention after paint application and paper pattern form removal.

FIG. 9 is a cut section thru the paper pattern of the present invention.

### DETAILED DESCRIPTION

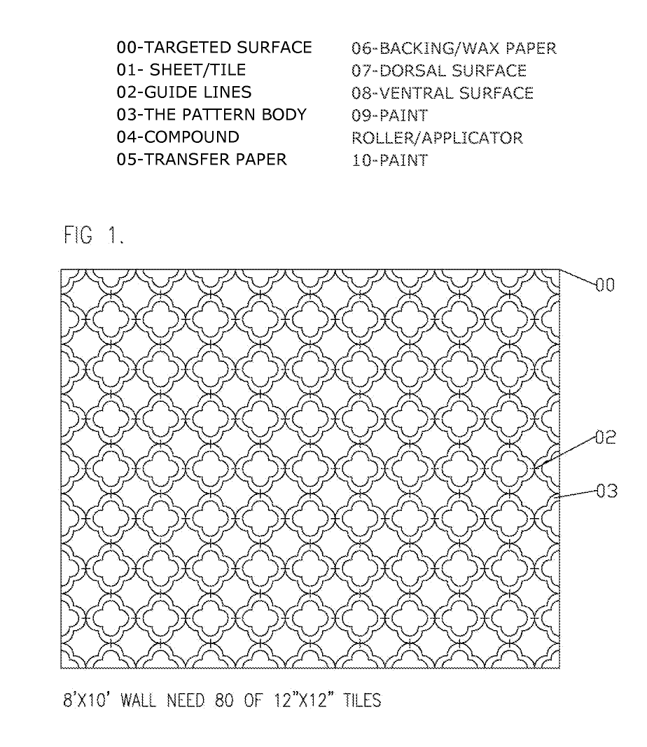

FIG. 1, shows an 8′×10′ wall 00 (an example of targeted surface) application of individual sheets or tiles 01 of pattern compound paper. Wall is first painted with color of the desired revealed pattern; the pattern 03 is adhered to the whole or a desired portion of the wall or surface 00 using guide-lines for alignment. Different paint color is applied to the whole wall or surface painting over the adhered pattern 03 and then the pattern paper is removed revealing the paint color underneath.

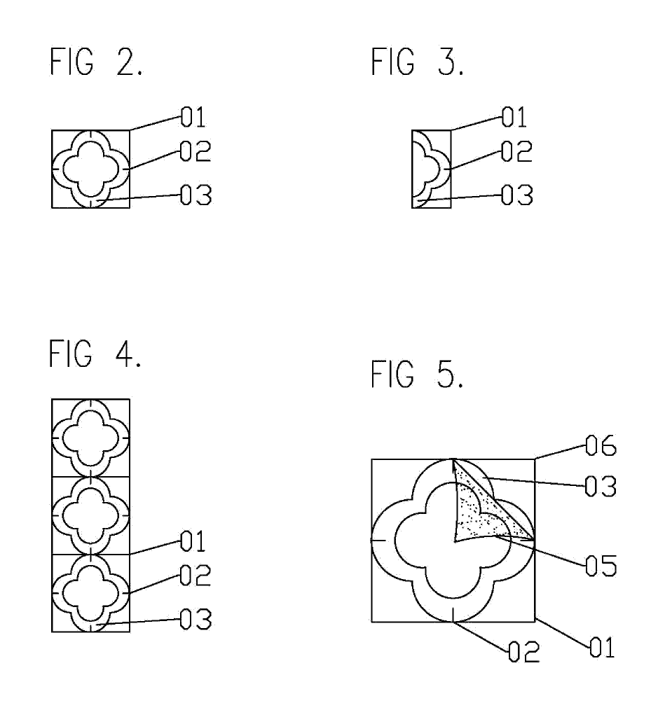

FIG. 2, a single sheet or tile 01 of the adhesive body 03 is shown. The guide lines 02 on all four sides to guide the alignment of the adjoining body 03 to allow a continuous pattern to be created.

FIG. 3, half of single sheet or tile of the adhesive body 03 is shown. The tile 01 can be cut in half following the guide lines 02 to create an edge outer recess reveal pattern, if so desired.

FIG. 4, shows an adhesive strip of several adjoining sheets or tiles 01 of the present invention curvilinear pattern body 03 example and guide lines 02 to guide for adjoining application. There are many different patterns that can be applied to the present invention and longer strips can be rolled for storage.

In FIG. 5, a single sheet or tile 01 of the pattern body 03, showing the clear transfer paper 05 on the dorsal surface of the pattern being peeled off and backing or wax paper 06 on the ventral surface of the pattern body 03. The backing or wax paper is removed prior to application onto the wall or target surface, the tile 01 is aligned with the adjoining tiles using guide lines 02 and is adhered to the transfer surface. Then the clear transfer paper 05 is removed and the pattern body is ready for paint application.

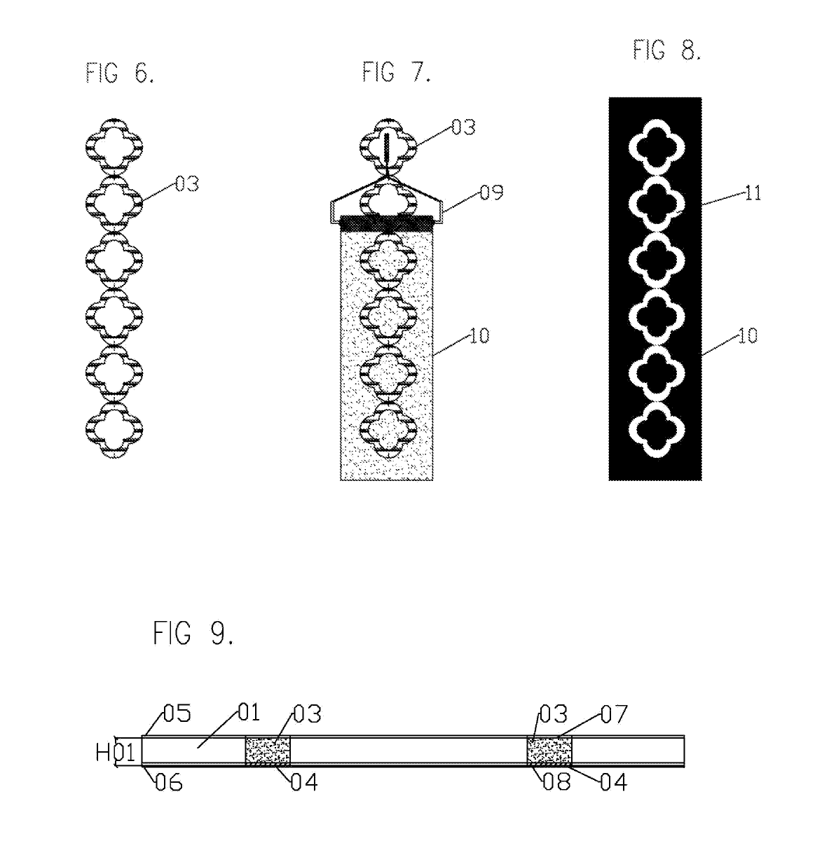

FIGS. 6-8, illustrate the adhesive pattern body 03 in use on a target surface. Turning to FIG. 6, an appropriate number of the decorative sheets or tiles 01 are selected; backing or wax paper is removed and are adhered to a target surface following in line with guidelines 02. An effective number of sheets or tiles will depend on the personal taste of the user in deciding the number of painted decorations, supplied by the patterns (shaded with lines for contrast). After the desired number of the decorative adhesive sheet or tile patterns 01 is placed, the clear transfer paper is removed and paint is applied to the wall as well as the 03 body of the patter as is shown in FIG. 7. The amount of paint 10 applied should include an amount required to cover the area of the target surface as exposed by the decorative pattern body 03. Although the paint 10 can be rolled onto the targeted surface using a paint roller 09 shown, an appropriately-sized brush or a paint spraying device may be used. The present invention is, however, not meant to be restricted to any particular type of paint application method.

FIG. 8 demonstrates the result after the decorative adhesive pattern body 03 was removed from the target surface after painting. An end of the decorative adhesive strip is grasped and pulled away from the target surface in the direction of the dorsal surface of the body 03. On the portions of the target surface (shown as solid dark paint) exposed by the pattern body 03, are decorations (shown as clear figures) painted on to the target surface. Because the adhesive compound of the present invention is adapted to both hinder unwanted paint migration and minimize adhesive residue, the painted decorations are substantially similar to the configuration of the pattern body 03 and the target surface is not extensively filled with residue.

FIG. 9, the dimensions of the adhesive pattern sheet or tile pattern form 01 can be viewed more clearly. The clear transfer paper 05 is on top of the dorsal surface 07 of the pattern body 03 to help with placement of the pattern and align the pattern correctly with the adjoining piece. The backing or wax paper 06 is protecting the adhesive compound 04 on the ventral surface of the pattern body 03. There is no one specific required decorative shape for the pattern body; the body may be formed in any shape that is decorative. Preferred decorative shapes include geometric shapes, scenic designs, curvilinear and circular shapes, and repeated undulating patterns.

The pattern body 03 of the present invention are portions of the body that have been previously excised from a sheet of compound paper. The pattern body 03 exists to prevent from the passage of paint through, or past, the body.

The pattern body 03, possessing the dorsal surface 07 and the ventral surface 08, further includes an adhesive compound 04 disposed upon the ventral surface 08 and is covered with backing or wax paper 06. The body height H01 of the decorative adhesive sheet or tile is uniform. By uniform height, it is meant that for most significant points of the dorsal surface 07, there will be a point directly beneath on the ventral surface 08. This allows for paint to be distributed evenly over the pattern body 03 and on to a target surface 00. The adhesive compound 04 can be situated on the ventral surface 08 of the body 03 in a distinct layer, or the adhesive compound 04 can be spread upon the ventral surface 08 in amounts effective merely to both bind the adhesive body 03 to a predetermined target surface 00 and prevent substantial unwanted paint migration. Unwanted paint migration occurs when paint bound for portions of the target surface exposed along the perimeter of the adhesive pattern body 03 seeps under the ventral surface of the adhesive pattern body 03. This paint “bleeding” occurs typically when an adhesive compound is used that lacks the chemical bonding strength to seal tape to a surface, or bleeding could occur because the adhesive compound is not spread appropriately upon the ventral surface of tape. Such inappropriate adhesive compounds and inadequate distributions are to be avoided in the present invention.

General tape adhesives are inadequate for the pattern body 03 of the present invention. The purpose of most conventional tapes is to bond two articles in close relation for an indefinite amount of time. The adhesive of the present invention adheres in a specific fashion and removes cleanly. As a primary purpose of the present invention is to allow simple paint decoration, it is likely that the pattern body 03 will be placed on multiple varieties of target surfaces 00. By target surfaces, it is meant any type of surface commonly painted in a decorative fashion, including doors, window casings, wood, walls, metals, cloth, etc.

The adhesive compound is a substance capable of bonding to a surface for a limited period of time leaving only an insubstantial amount of residue. The ideal adhesives for the present invention include those found, or capable of use, in painters' tape. Painters' tape adhesives are made for use in projects where the tape will adhere to a surface for less than a specified period of time, and if released prior to that specified period of time, with leave substantially no residue on the target surface. Although conventional tapes are capable, to a certain extent, of shielding a surface from paint, when removed, the conventional tape will leave a sticky, unsightly residue where the conventional tape formerly resided. Painters' tape, however, when removed prior to its rating time will leave no substantial residue. That is to say, any clean up time or work will be minimal, and the average viewer would not be able to ascertain the portion of the surface that had previously been covered by the painters' tape.

Painters' tape can be purchased with various adhesive compositions. The primary system used in grading painters' tape adhesive compositions is by stating the number of days that the tape can be left on a surface without residue remaining after tape removal. Many grades of painters' tape exist such as grades 1, 3, 30 and 60. Each grade of adhesive has its own sets of strengths and weaknesses; grade 60 adheres minimally and is generally only for use with very smooth, delicate surfaces such as vinyl wallpaper or freshly painted walls, grade 1 for example can be used with common wood surfaces and metals.

Most of the adhesive compounds currently used with painters' tape would apply to the present invention. Painters' tapes typically include an adhesive comprised of a pressure-sensitive acryl-based resin. Acrylic adhesives have a low initial bonding strength, and it typically takes many hours—and depending upon additives, possibly days—for the compound to reach its maximum adhering strength. Acryl-based adhesives have a small initial tacking property and therefore can be repeatedly peeled off and stuck from and to a surface. Additionally, rubber-based adhesives and other adhesives commonly used with masking tape may be used with the present invention. Common masking tape adhesives, however, tend to only work on smooth surfaces, it does not work reliably on wood trim, and interior wall surfaces without environmental assistance, e.g. heating a room to approximately 80 degrees Fahrenheit prior to painting to increase the sealing properties of the tape to the target surface. For this reason, masking tape adhesive compositions are not preferred, but do apply to the present invention. The adhesives common in duct tape, electrical tape, packaging tape, or any of the other tapes on the market that are designed for purposes other than painting are generally incapable of sealing sufficiently to hold back paint, and more often than not, such adhesive compounds will adhere so well that damage accrues to the underlying surface when removed.

The adhesive compound necessary to the present invention fulfills two requirements lacking in ordinary tapes. The adhesive compound must seal to a degree necessary to hold back paint, but not seal to such an extent that damage to the underlying surface occurs upon removal. The particular amount of tack required for the adhesive will depend upon the particular embodiment of the adhesive strip. As the choices of adhesive compounds as they relate to tack and sealing properties are well established in the art, it would inappropriate to catalogue them here.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

### CITATIONS

### Patent: U.S. 2008/0020181

Filing date: Jan. 24, 2008

### Inventor: Ann Marie Chafoulias

Title: Decorative adhesive strip for paint application
Patent: U.S. Pat. No. 4,430,137
Filing date: Feb. 7, 1984

### Original Assignee: The Excello Specialty Company

Title: Paint mask and method

1. A column or row of individual decorative sheets or tiles of compound paper cut into shapes (pattern forms) for applying a continual curvilinear, circular or geometric pattern of paint to a target surface; used similarly to painters' tape to create straight-edged geometric patterns on the targeted surface, said sheet comprising of: an individual sheet with an adhesive pattern body height; said sheet body having a dorsal surface and a ventral surface; and a cleanly releasable adhesive compound, contacting said ventral surface of said body, adapted to attach and seal the target surface with adhesion rating of at least 1.

2. The decorative sheets or tiles of compound paper pattern forms of claim 1 wherein said multiple pattern forms create a repeating pattern if adjacent to one another.

3. The decorative sheets of compound paper pattern forms of claim 2 wherein said forms of pattern are outer recesses, inner recesses or a combination of both.

4. The decorative sheets of compound paper pattern forms of claim 2 wherein said body consists of a single layer of material; most may need a wax paper backing that is peeled off before the application to the target surface and in delicate patterns need a transfer paper on dorsal surface.

5. The decorative sheets of compound paper forms of claim 2 wherein said adhesive includes a rubber-based adhesive.

6. The decorative sheets of compound paper forms of claim 2 wherein said adhesive includes an acrylic-based adhesive.

7. Longer strips of several individual sheets or tiles of decorative compound paper pattern forms in a straight line attached to each other (floor to ceiling in length for example) for applying a continuous painted pattern to a target surface, said long stripe or a continuation of several sheets comprising: a continuous body, having a dorsal surface and a ventral surface, with multiple pattern forms, and wherein said continuous body is wound in a roll for storage; and a cleanly releasable adhesive compound, contacting said ventral surface of said body, adapted to attach and seal the target surface with adhesion rating of at least 1.

9. The decorative sheets or tiles of compound paper pattern forms of claim 8 wherein said multiple pattern forms create a repeating pattern if adjacent to one another.

10. The decorative sheets of compound paper pattern forms of claim 9 wherein said pattern forms are outer recesses, inner recesses or a combination of both.

11. The decorative sheets of compound paper pattern forms of claim 9 wherein said body consists of a single layer of material; most may require a wax paper backing that is peeled off before the application to the target surface; other patterns may require clear transfer paper on the dorsal surface to be peeled after the application to the target surface.

12. The decorative sheets of compound paper pattern forms of claim 9 wherein said adhesive includes a rubber-based adhesive.

13. The decorative sheets of compound paper pattern forms of claim 9 wherein said adhesive includes an acrylic-based adhesive.
